(19) United States
(12) Patent Application Publication
(10) Pub. No.: US 2018/0327537 A1
(43) Pub. Date: Nov. 15, 2018

(54) POLYURETHANE FOAMS BASED ON POLYETHER CARBONATE POLYOLS

(71) Applicant: COVESTRO DEUTSCHLAND AG, Leverkusen (DE)

(72) Inventors: Matthäus GOSSNER, Köln (DE); Lutz BRASSAT, Leverkusen (DE); Bert KLESCZEWSKI, Köln (DE)

(73) Assignee: COVESTRO DEUTSCHLAND AG, Leverkusen (DE)

(21) Appl. No.: 15/776,513

(22) PCT Filed: Nov. 17, 2016
(86) PCT No.: PCT/EP2016/078033

§ 371 Date: May 16, 2018

(30) Foreign Application Priority Data
Nov. 19, 2015 (EP) 15195288.4

(51) Int. Cl. C08G 18/48; C08G 18/18; C08G 18/24; C08G 18/76; C08G 18/16; C08J 9/12

(52) U.S. Cl. CPC C08G 18/4816; C08G 18/4887; C08G 18/485; C08G 18/1841; C08G 2101/0008; C08G 18/244; C08G 18/7621; C08G 18/165; C08J 9/125; C08G 18/1833

(57) ABSTRACT

The present invention concerns a method for producing polyurethane foams by reacting an isocyanate component with a component reactive to isocyanates, which comprises at least one polyether carbonate polyol, and wherein the reaction takes place in the presence of urea or derivatives thereof. Furthermore, the invention concerns polyurethane foams produced by the method according to the invention and their application.

### CROSS-REFERENCE TO RELATED APPLICATIONS

This application is a national stage application under 35 U.S.C. § 371 of PCT/EP2016/078033, filed Nov. 17, 2016, which claims the benefit of European Application No. 15195288.4, filed Nov. 19, 2015, both of which are being incorporated by reference herein.

### FIELD

The present invention concerns a method for producing polyurethane foams, preferably flexible polyurethane foams, by reacting an isocyanate component with a component reactive to isocyanates, which comprises at least one polyether carbonate polyol, and wherein the reaction takes place in the presence of urea or derivatives thereof. Furthermore, the invention concerns polyurethane foams produced by the method according to the invention and their application.

### BACKGROUND

In the context of an environmentally friendly focus on production processes, it is generally desirable to use CO₂-based starting materials, for example, in the form of polyether carbonate polyols, in relatively large amounts.

The production of polyurethane foams based on polyether carbonate polyols and isocyanates is known (e.g. WO 2012/130760 A1, EP-A 0 222 453). Typically, aminic catalysts are used as catalysts. But, when these types of aminic catalysts are used, when foaming takes place, re-splitting reactions take place in the polyether carbonate polyols that are used, resulting in the release of cyclic propylene carbonate amongst other things. On the one hand, this reduces the CO₂ content in the foam and, on the other hand, results in undesirable emissions.

### SUMMARY

Accordingly, the present invention has for its object, the provision of a method for producing polyurethane foams wherein the emission of cyclic propylene carbonate is reduced to the greatest possible extent.

Surprisingly, this object was achieved by a method for producing polyurethane foams in which the reaction of an isocyanate component B with an isocyanate-reactive component A, which comprises at least one polyether carbonate polyol, is carried out in the presence of urea or derivatives thereof and the content of aminic catalysts is kept low. Accordingly, the subject matter of the invention is a method for producing polyurethane foams, preferably flexible polyurethane foams, by a reaction of
A1 ≥40 to ≤100 parts by wt. of one or more polyether carbonate polyols having a hydroxyl number according to DIN 53240 of ≥20 mg of KOH/g to ≤120 mg of KOH/g,
A2 ≤60 to ≥0 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,

A3 ≤20 to ≥0 parts by wt., relative to the sum of the parts by wt. of components A1 and A2, of one or more polyether polyols having a hydroxyl number according to DIN 53240≥20 mg of KOH/g to ≤250 mg of KOH/g, and a content of ethylene oxide of >60% w/w, wherein the polyether polyols A3 are free from carbonate units,

A4 ≤40 to ≥0 parts by wt., relative to the sum of the parts by wt. of components A1 and A2, of one or more polymer polyols, PHD polyols and/or PIPA polyols,

A5 ≤40 to ≥0 parts by wt., relative to the sum of the parts by wt. of components A1 and A2, of polyols which do not fall under the definition of components A1 to A4,

B1 ≥0.05 to ≤1.5 parts by wt., relative to the sum of the parts by wt. of components A1 and A2, of urea and/or derivatives of the urea,

B2 ≥0.03 to ≤1.5 parts by wt., relative to the sum of the parts by wt. of components A1 and A2, of catalysts other than those of component B1, wherein the content of aminic catalysts in component B2 may be no greater than 50% w/w relative to component B1, with

C Di and/or polyisocyanates,

D Water and/or physical propellants,

E Excipients and additives as required,

wherein production takes place at an index of ≤90 to ≤120,

wherein all stated parts by weight of components A1, A2, A3, A4, A5, B1 and B2 are normalised such that the sum of the parts by weight A1+A2 totals 100 in the composition.

Neither urea nor its derivatives belong to the “aminic catalysts” mentioned in B2.

### DETAILED DESCRIPTION

The components A1 to A5 refer respectively to “one or more” of the quoted compounds. The use of more compounds of a component corresponds to the stated quantity of the sum of the parts by weight of the compounds.

In one embodiment (I), component A comprises

A1 ≥40 to ≤100 parts by wt., preferably ≥60 to ≤100 parts by wt., especially preferably ≥80 to ≤100 parts by wt. of one or more polyether carbonate polyols having a hydroxyl number according to DIN 53240 of ≥20 mg of KOH/g to ≤120 mg of KOH/g, and

A2 ≤60 to ≥0 parts by wt., preferably ≥40 to ≤0 parts by wt., especially preferably ≥20 to ≤0 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,

A5 ≤40 to ≥0 parts by wt., relative to the sum of the parts by wt. of components A1 and A2, of polyols which do not fall under the definition of components A1 to A4,

wherein component A is preferably free from component A3 and A4.

In this case, the stated ranges and preferable ranges of components A1, A2, A3 and A5 can be combined freely with one another.

In a preferable embodiment (Ia), component A comprises

A1 ≥65 to ≤75 parts by wt. of one or more polyether carbonate polyols having a hydroxyl number according to DIN 53240 of ≥20 mg of KOH/g to ≤120 mg of KOH/g, and

A2 ≤35 to ≥25 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,

wherein component A is preferably free from component A3 and A4.

In an especially preferable embodiment (Ib), component A comprises

A1 ≥65 to ≤75 parts by wt. of one or more polyether carbonate polyols having a hydroxyl number according to DIN 53240 of ≥20 mg of KOH/g to ≤120 mg of KOH/g, and a CO₂ content of 15 to 25% w/w

A2 ≤35 to ≥25 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,

wherein component A is preferably free from component A3 and A4.

In a particularly specially preferable embodiment (Ic) component A comprises

A1 ≥68 to ≤72 parts by wt. of one or more polyether carbonate polyols having a hydroxyl number according to DIN 53240 of ≥20 mg of KOH/g to ≤120 mg of KOH/g, and a CO₂ content of 18 to 22% w/w

A2 ≤32 to ≥28 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,

wherein component A is preferably free from component A3 and A4.

In an alternative embodiment (II), component A comprises
A1 ≥40 to ≤100 parts by wt., preferably ≥60 to ≤100 parts by wt., especially preferably ≥80 to ≤100 parts by wt. of one or more polyether carbonate polyols having a hydroxyl number according to DIN 53240 of ≥20 mg of KOH/g to ≤120 mg of KOH/g, and

A2 ≤60 to ≥0 parts by wt., preferably ≥40 to ≤0 parts by wt., especially preferably ≥20 to ≤0 parts by wt. of one or more polyether polyols having a hydroxyl number according to DIN53240 of ≥20 mg of KOH/g to ≤250 mg of KOH/g and a content of ethylene oxide of ≥0 to ≤60% w/w, wherein the polyether polyols A2 are free from carbonate units,

A3 ≤20 to ≥0.01 parts by wt., preferably ≤10 to ≥0.01 parts by wt., especially preferably ≤10 to ≥1 parts by wt., relative to the sum of the parts by wt. of components A1 and A2, of one or more polyether polyols having a hydroxyl number according to DIN 53240≥20 mg of KOH/g to ≤250 mg of KOH/g, and a content of ethylene oxide of >60% w/w, wherein the polyether polyols A3 are free from carbonate units, and

A5 ≤40 to ≥0 parts by wt., relative to the sum of the parts by wt. of components A1 and A2, of polyols which do not fall under the definition of components A1 to A4,

wherein component A is preferably free from component A3.

In this case, the stated ranges and preferable ranges of components A1, A2, A3 and A5 can be combined freely with one another.

In a preferable embodiment (IIa), component A comprises

A1 ≥65 to ≤75 parts by wt. of one or more polyether carbonate polyols having a hydroxyl number according to DIN 53240 of ≥20 mg of KOH/g to ≤120 mg of KOH/g, and

A2 ≤35 to ≥25 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,

A3 ≤20 to ≥2 parts by wt., relative to the sum of the parts by wt. of components A1 and A2, of one or more polyether polyols having a hydroxyl number according to DIN 53240≥20 mg of KOH/g to ≤250 mg of KOH/g, and a content of ethylene oxide of >60% w/w, wherein the polyether polyols A3 are free from carbonate units,

wherein component A is preferably free from component A4.

In an especially preferable embodiment (IIb), component A comprises

A1 ≥65 to ≤75 parts by wt. of one or more polyether carbonate polyols having a hydroxyl number according to DIN 53240 of ≥20 mg of KOH/g to ≤120 mg of KOH/g, and a CO₂ content of 15 to 25 w/w

A2 ≤35 to ≥25 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,

A3 ≤20 to ≥2 parts by wt., relative to the sum of the parts by wt. of components A1 and A2, of one or more polyether polyols having a hydroxyl number according to DIN 53240≥20 mg of KOH/g to ≤250 mg of KOH/g, and a content of ethylene oxide of >60% w/w, wherein the polyether polyols A3 are free from carbonate units,

wherein component A is preferably free from component A4.

In a particularly specially preferable embodiment (IIc), component A comprises

A1 ≥67 to ≤72 parts by wt. of one or more polyether carbonate polyols having a hydroxyl number according to DIN 53240 of ≥20 mg of KOH/g to ≤120 mg of KOH/g, and a CO₂ content of 18 to 22% w/w

A2 ≤33 to ≥28 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,

A3 ≤20 to ≥2 parts by wt., relative to the sum of the parts by wt. of components A1 and A2, of one or more polyether polyols having a hydroxyl number according to DIN 53240≥20 mg of KOH/g to ≤250 mg of KOH/g, and a content of ethylene oxide of >60% w/w, wherein the polyether polyols A3 are free from carbonate units,

wherein component A is preferably free from component A4.

In an even more preferable embodiment (IId), component A comprises

A1 ≥67 to ≤72 parts by wt. of one or more polyether carbonate polyols having a hydroxyl number according to DIN 53240 of ≥20 mg of KOH/g to ≤120 mg of KOH/g, and a CO₂ content of 18 to 22% w/w

A2 ≤33 to ≥28 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,

A3 ≤10 to ≥2 parts by wt., relative to the sum of the parts by wt. of components A1 and A2, of one or more polyether polyols having a hydroxyl number according to DIN 53240≥20 mg of KOH/g to ≤250 mg of KOH/g, and a content of ethylene oxide of >60% w/w, wherein the polyether polyols A3 are free from carbonate units,

wherein component A is preferably free from component A4.

In a further alternative embodiment (III), component A comprises

A1 ≥40 to ≤100 parts by wt., preferably ≥60 to ≤100 parts by wt., especially preferably ≥80 to ≤100 parts by wt. of one or more polyether carbonate polyols having a hydroxyl number according to DIN 53240 of ≥20 mg of KOH/g to ≤120 mg of KOH/g, and

A2 ≤60 to ≥0 parts by wt., preferably ≥40 to ≤0 parts by wt., especially preferably ≥20 to ≤0 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,

A4 ≤40 to ≥0.01 parts by wt., preferably ≤20 to ≥0.01 parts by wt., especially preferably ≤20 to ≥1, relative to the sum of the parts by wt. of components A1 and A2, of one or more polymer polyols, PHD polyols and/or PIPA polyols,

A5 ≤40 to ≥0 parts by wt., relative to the sum of the parts by wt. of components A1 and A2, of polyols which do not fall under the definition of components A1 to A4,

wherein component A is preferably free from component A3.

Here, the stated ranges and preferable ranges of components A1, A2, A3 and A5 can be combined freely with one another.

In a preferable embodiment (IIIa), component A comprises

A1 ≥65 to ≤75 parts by wt. of one or more polyether carbonate polyols having a hydroxyl number according to DIN 53240 of ≥20 mg of KOH/g to ≤120 mg of KOH/g, and

A2 ≤35 to ≥25 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,

A4 ≤20 to ≥2 parts by wt., relative to the sum of the parts by wt. of components A1 and A2, of one or more polymer polyols, PHD polyols and/or PIPA polyols.

wherein component A is preferably free from component A3.

In an especially preferable embodiment (IIIb), component A comprises

A1 ≥65 to ≤75 parts by wt. of one or more polyether carbonate polyols having a hydroxyl number according to DIN 53240 of ≥20 mg of KOH/g to ≤120 mg of KOH/g, and a CO₂ content of 15 to 25% w/w

A2 ≤35 to ≥25 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,

A4 ≤20 to ≥2 parts by wt., relative to the sum of the parts by wt. of components A1 and A2, of one or more polymer polyols, PHD polyols and/or PIPA polyols,

wherein component A is preferably free from component A3.

In a particularly especially preferable embodiment (IIIc), component A comprises

A1 ≥67 to ≤72 parts by wt. of one or more polyether carbonate polyols having a hydroxyl number according to DIN 53240 of ≥20 mg of KOH/g to ≤120 mg of KOH/g, and a CO₂ content of 18 to 22% w/w

A2 ≤33 to ≥28 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,

A4 ≤20 to ≥2 parts by wt., relative to the sum of the parts by wt. of components A1 and A2, of one or more polymer polyols, PHD polyols and/or PIPA polyols,

wherein component A is preferably free from component A3.

In an even more preferable embodiment (IIId), component A comprises

A1 ≥67 to ≤72 parts by wt. of one or more polyether carbonate polyols having a hydroxyl number according to DIN 53240 of ≥20 mg of KOH/g to ≤120 mg of KOH/g, and a CO₂ content of 18 to 22% w/w

A2 ≤33 to ≥28 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,

A4 ≤10 to ≥2 parts by wt., relative to the sum of the parts by wt. of components A1 and A2, of one or more polymer polyols, PHD polyols and/or PIPA polyols,

wherein component A is preferably free from component A3.

The components used in the method according to the invention are described in more detail below.

### Component A1

Component A1 comprises a polyether carbonate polyol having a hydroxyl number (OH number) according to DIN 53240 of ≥20 mg of KOH/g to ≤120 mg of KOH/g, preferably of ≥20 mg of KOH/g to ≤100 mg of KOH/g, especially preferably of ≥25 mg of KOH/g to ≤90 mg of KOH/g, which is obtained by copolymerisation of carbon dioxide, one or more alkylene oxides, in the presence of one or more H-functional starter molecules, wherein the polyether carbonate polyol preferably has a CO₂ content of 15 to 25% w/w. Preferably, component A1 comprises a polyether carbonate polyol, which is obtained by copolymerisation of ≥2% w/w to ≤30% w/w of carbon dioxide and ≥70% w/w to ≤98% w/w of one or more alkylene oxides, in the presence of one or more H-functional starter molecules with an average functionality of ≥1 to ≤6, preferably of ≥1 and ≤4, especially preferably ≥2 and ≤3. Within the context of the invention, “H-functional” is meant as a starter compound having alkoxylation-active H atoms.

Preferably, the copolymerisation of carbon dioxide and one or more alkylene oxides takes place in the presence of at least one DMC catalyst (double metal cyanide catalyst).

Preferably, the polyether carbonate polyols used in accordance with the invention also have ether groups between the carbonate groups, shown schematically in formula (IX). In the scheme according to formula (IX), R represents an organic radical such as alkyl, alkylaryl or aryl, each of which may contain heteroatoms, for example, O, S, Si etc., while e and f are integers. The polyether carbonate polyol shown in the scheme according to formula (IX) is to be understood as meaning merely that blocks having the structure shown may, in principle, be present again in the polyether carbonate polyol, while the sequence, number and length of the blocks may vary, however, and is not limited to the polyether carbonate polyol shown in formula (IX). As for formula (IX), this means that the e/f ratio is preferably from 2:1 to 1:20, especially preferably from 1.5:1 to 1:10.

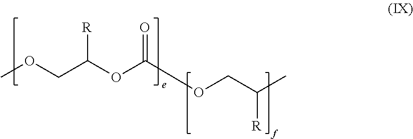

The proportion of incorporated CO₂ (“units originating from carbon dioxide”; “CO₂ content”) in a polyether carbonate polyol can be determined from the evaluation of characteristic signals in the ¹H NMR spectrum. The following example illustrates the determination of the proportion of units originating from carbon dioxide in a 1,8-octanediol-started CO₂/propylene oxide/polyether carbonate polyol.

The proportion of CO₂ incorporated in a polyether carbonate polyol and the ratio of propylene carbonate to polyether carbonate polyol can be determined by ¹H NMR (a suitable device is obtainable from Bruker, DPX 400, 400 MHz; zg30 pulse programme, delay time d1: 10 sec., 64 scans). Each sample is dissolved in deuterated chloroform. The relevant resonances in the ¹H-NMR (based on TMS=0 ppm) are as follows:

Cyclic propylene carbonate (which was formed as a by-product) with a resonance at 4.5 ppm; carbonate resulting from carbon dioxide incorporated in the polyether carbonate polyol having resonances at 5.1 to 4.8 ppm; unreacted propylene oxide (PO) with a resonance at 2.4 ppm; polyether polyol (i.e. without incorporated carbon dioxide) with resonances at 1.2 to 1.0 ppm; the 1,8 octanediol incorporated as a starter molecule (if present) with a resonance at 1.6 to 1.52 ppm.

The proportion by weight (in % w/w) of the carbonate incorporated in the polymer (LC′) in the reaction mixture was calculated using formula (I),

$${LC}^{′} = \frac{[ F ( 5.1 - 4.8 ) - F ( 4.5 ) ] * 102}{N} * 100 \% \qquad ( I )$$

wherein the value for N (“denominator” N) is calculated using formula (II):

N=[F(5.1-4.8)−F(4.5)]*102+F(4.5)*102+F(2.4)*58+0.33*F(1.2-1.0)*58+0.25*F(1.6-1.52)*146 (II)

wherein the following abbreviations are used:

F(4.5)=area of the resonance at 4.5 ppm for cyclic carbonate (corresponds to an H atom)

F(5.1-4.8)=area of the resonance at 5.1-4.8 ppm for polyether carbonate polyol and an H atom for cyclic carbonate.

F(2.4)=area of the resonance at 2.4 ppm for free, unreacted PO

F(1.2-1.0)=area of the resonance at 1.2-1.0 ppm for polyether polyol

F(1.6-1.52)=area of the resonance at 1.6 to 1.52 ppm for 1,8 octanediol (starter), if present.

The factor 102 results from the sum of the molar masses of CO₂ (molar mass 44 g/mol) and of propylene oxide (molar mass 58 g/mol), the factor 58 results from the molar mass of propylene oxide and the factor 146 results from the molar mass of the 1,8-octanediol starter used (if present).

The proportion by weight (in % w/w) of cyclic carbonate (CC′) in the reaction mixture was calculated using formula (III),

$${CC}^{′} = \frac{F ( 4.5 ) * 102}{N} * 100 \% \qquad ( III )$$

wherein the value for N is calculated using formula (II).

In order to calculate the composition based on the polymer fraction (consisting of polyether polyol constructed from starter and propylene oxide during the activation steps which take place under CO₂-free conditions, and polyether carbonate polyol, constructed from starter, propylene oxide and carbon dioxide during the activation steps which take place in the presence of CO₂ and during the copolymerisation) from the values for the composition of the reaction mixture, the non-polymer components of the reaction mixture (i.e. cyclic propylene carbonate and any unreacted propylene oxide) were mathematically eliminated. The weight fraction of the carbonate repeat units in the polyether carbonate polyol was converted to a weight fraction of carbon dioxide using the factor F=44/(44+58). The value of the CO₂ content in the polyether carbonate polyol is normalised to the proportion of the polyether carbonate polyol molecule which was formed in the copolymerisation and any activation steps in the presence of CO₂ (i.e. the proportion of the polyether carbonate polyol molecule resulting from the starter (1,8-octanediol, if present) and from the reaction of the starter with epoxide, added under CO₂-free conditions, was not taken into account here).

For example, the production of polyether carbonate polyols according to A1 comprises the following:

(α) an H-functional starter substance or a mixture of at least two H-functional starter substances are initially charged and any water and/or other volatile compounds are removed through elevated temperature and/or reduced pressure (“drying”), wherein the DMC catalyst is added to the H-functional starter substance or to the mixture of at least two H-functional starter substances before or after drying,

(β) activation by adding a portion (based on the total amount of alkylene oxides used in the activation and copolymerisation) of one or more alkylene oxides to the mixture resulting from step (α), wherein this addition of a portion of alkylene oxide may take place possibly in the presence of CO₂, and wherein the temperature peak (“hotspot”), occurring due to the subsequent exothermic chemical reaction, and/or a pressure drop in the reactor is anticipated in each case, and wherein the step (β) to activate may be performed repeatedly,

(γ) the addition of one or more of the alkylene oxides and carbon dioxide to the mixture resulting from step (β), wherein the alkylene oxides used in step (β) may be identical to or different from the alkylene oxides used in step (γ).

Generally, alkylene oxides (epoxides) with 2 to 24 carbon atoms may be used to produce the polyether carbonate polyols A1. The alkylene oxides with 2 to 24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, one or more epoxidised fats such as mono-, di- and triglycerides, epoxidised fatty acids, C₁-C₂₄ esters of epoxidised fatty acids, epichlorohydrin, glycidol, and derivatives of glycidol, such as methyl glycidyl ether, ethyl glycidyl ether, 2-ethylhexyl glycidyl ether, allyl glycidyl ether, glycidyl methacrylate and epoxy-functional alkoxysilanes, such as 3-glycidyloxypropyltrimethoxysilane, 3-glycidyioxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. Preferably, the alkylene oxides used are ethylene oxide and/or propylene oxide and/or 1,2 butylene oxide, particularly preferably propylene oxide.

In a preferable embodiment of the invention, the proportion of ethylene oxide in the overall amount used of propylene oxide and ethylene oxide is ≥0 and ≤90% w/w, preferably ≥0 and ≤50 w/w and especially preferably free from ethylene oxide.

Compounds with alkoxylation-active H atoms can be used as a suitable H-functional starter substance. Alkoxylation-active groups having active H atoms are, for example, —OH, —NH₂ (primary amines), —NH— (secondary amines), —SH and —CO₂H, preferably —OH and —NH₂, and —OH is especially preferable. An H-functional starter substance which is used is, for example, one or more compounds selected from the group consisting of water, mono- or polyvalent alcohols, polyvalent amines, polyvalent thiols, amino alcohols, thiol alcohols, hydroxy esters, polyether polyols, polyester polyols, polyester ether polyols, polyether carbonate polyols, polycarbonate polyols, polycarbonates, polyethylene imines, polyetheramines (e.g. so-called Jeffamines® from Huntsman, such as D-230, D-400, D-2000, T-403, T-3000, T-5000 or corresponding BASF products, such as Polyetheramine D230, D400, D200, T403, T5000), polytetrahydrofuranes (e.g. PolyTHF® from BASF, such as PolyTHF® 250, 650S, 1000, 1000S, 1400, 1800, 2000), polytetrahydrofuranamines (BASF product Polytetrahydrofuranamine 1700), polyether thiols, polyacrylate polyols, castor oil, the mono- or diglyceride of ricinoleic acid, monoglycerides of fatty acids, chemically modified mono-, di- and/or triglycerides of fatty acids, and C₁-C₂₄ alkyl fatty acid esters containing on average at least 2 OH groups per molecule. The C₁-C₂₄ alkyl fatty acid esters containing on average at least 2 OH groups per molecule are available commercially, for example, as Lupranol Balance® (BASF AG), the Merginol® range (Hobum Oleochemicals GmbH), the Sovermol® range (Cognis Deutschland GmbH & Co. KG) and the Soyol®™ range (USSC Co.).

Monofunctional starter compounds that may be used are alcohols, amines, thiols and carboxylic acids. Monofunctional alcohols that may be used are: methanol, ethanol, 1-propanol, 2-propanol, 1-butanol, 2-butanol, t-butanol, 3-buten-1-ol, 3-butyn-1-ol, 2-methyl-3-buten-2-ol, 2-methyl-3-butyn-2-ol, propagyl alcohol, 2-methyl-2-propanol, 1-t-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Monofunctional amines worth considering are: butylamine, t-butylamine, pentylamine, hexylamine, aniline, aziridine, pyrrolidine, piperidine, morpholine. The following can be used as monofunctional thiols: ethanethiol, 1-propanethiol, 2-propanethiol, 1-butanethiol, 3-methyl-1-butanethiol, 2-butene-1-thiol, thiophenol. Monofunctional carboxylic acids that may be mentioned are: formic acid, acetic acid, propionic acid, butyric acid, fatty acids such as stearic acid, palmitic acid, oleic acid, linoleic acid, linolenic acid, benzoic acid and acrylic acid.

Polyvalent alcohols suitable as H-functional starter substances are, for example, bivalent alcohols (such as, for example, ethylene glycol, diethylene glycol, propylene glycol, dipropylene glycol, 1,3-propanediol, 1,4-butanediol, 1,4-butenediol, 1,4-butynediol, neopentyl glycol, 1,5-pentantane diol, methylpentanediols (for example 3-methyl-1,5-pentanediol), 1,6-hexanediol; 1,8-octanediol, 1,10-decanediol, 1,12-dodecanediol, bis-(hydroxymethyl)-cyclohexanes (for example 1,4-bis-(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trivalent alcohols (for example trimethylolpropane, glycerol, trishydroxyethyl isocyanurate, castor oil); tetravalent alcohols (for example, pentaerythritol); polyalcohols (for example sorbitol, hexitol, sucrose, starch, starch hydrolysates, cellulose, cellulose hydrolysates, hydroxy-functionalised fats and oils, in particular castor oil), and all modification products of these alcohols mentioned above, with different amounts of ε-caprolactone. Trivalent alcohols also, such as trimethylolpropane, glycerol, trishydroxyethylisocyanurate and castor oil can be used in mixtures of H-functional starters.

The H-functional starter substances may also be selected from the substance class of the polyether polyols, in particular those having a molecular weight Mₙ in the range from 100 to 4000 g/mol, preferably 250 to 2000 g/mol. Preference is given to polyether polyols formed from repeating ethylene oxide and propylene oxide units, preferably with a proportion of 35 to 100% of propylene oxide units, especially preferably with a proportion of 50 to 100% of propylene oxide units. These may be random copolymers, gradient copolymers, alternating or block or copolymers of ethylene oxide and propylene oxide. Suitable polyether polyols, formed from repeating propylene oxide- and/or ethylene oxide units are for example, the Desmophen®-, Acclaim®-, Arcol®-, Baycoll®-, Bayfill®-, Bayflex®- Baygal®-, PET®- and polyether polyols from Covestro Deutschland AG (such as Desmophen® 3600Z, Desmophen® 1900U, Acclaim® Polyol 2200, Acclaim® Polyol 4000I, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004 and Polyether® S180). Further suitable homo-polyethylene oxides are, for example, the Pluriol® E brands from BASF SE, suitable homo-polypropylene oxides are, for example, the Pluriol® P brands from BASF SE, suitable mixed copolymers of ethylene oxide and propylene oxide are, for example, the Pluronic® PE or Pluriol® RPE brands from BASF SE.

The H-functional starter substances may also be selected from the substance class of the polyester polyols, in particular those having a molecular weight Mₙ in the range from 200 to 4500 g/mol, preferably 400 to 2500 g/mol. The polyester polyols employed are at least difunctional polyesters. Polyester polyols preferably consist of alternating acid and alcohol units. Acid components employed are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components used are, for example, ethanediol, 1,2-propanediol, 1,3-propanediol, 1,4-butanediol, 1,5-pentanediol, neopentyl glycol, 1,6-hexanediol, 1,4-bis(hydroxymethyl)cyclohexane, diethylene glycol, dipropylene glycol, trimethylolpropane, glycerol, pentaerythritol or mixtures of the alcohols mentioned. If the alcohol components used are divalent or polyvalent polyether polyols, the result is polyester ether polyols which can likewise serve as starter substances for preparation of the polyether carbonate polyols. If polyether polyols are used to prepare the polyester ether polyols, preference is given to polyether polyols having a number-average molecular weight Mₙ of 150 to 2000 g/mol.

The H-functional starter substances employed may additionally be polycarbonate polyols (for example polycarbonate diols), in particular those having a molecular weight Mₙ in the range from 150 to 4500 g/mol, preferably 500 to 2500, which are produced for example by reaction of phosgene, dimethyl carbonate, diethyl carbonate or diphenyl carbonate and di- and/or polyfunctional alcohols or polyester polyols or polyether polyols. Examples of polycarbonate polyols may be found in EP-A 1359177 for example. Examples of polycarbonate diols that may be used include the Desmophen® C range from Covestro Deutschland AG, for example Desmophen® C 1100 or Desmophen® C 2200.

Polyether carbonate polyols may likewise be used as H-functional starter substances. In particular, polyether carbonate polyols produced by the above-described process are used. To this end these polyether carbonate polyols used as H-functional starter substances are produced beforehand in a separate reaction step.

Preferred H-functional starter substances are alcohols of general formula (IV),

HO—(CH₂)ₓ—OH (IV)

wherein x is a number from 1 to 20, preferably an even number from 2 to 20. Examples of alcohols of formula (IV) are ethylene glycol, 1,4-butanediol, 1,6-hexanediol, 1,8-octanediol, 1,10-decanediol and 1,12-dodecanediol. Further preferred H-functional starter substances are neopentyl glycol, trimethylolpropane, glycerol, pentaerythritol, reaction products of the alcohols of formula (IV) with ε-caprolactone, for example, reaction products of trimethylolpropane with ε-caprolactone, reaction products of glycerol with ε-caprolactone and reaction products of pentaerythritol with ε-caprolactone. Water, diethylene glycol, dipropylene glycol, castor oil, sorbitol and polyether polyols formed from repeat polyalkylene oxide units are also preferably used as H-functional starter substances.

The H-functional starter substances are particularly preferably one or more compounds selected from the group consisting of ethylene glycol, propylene glycol, 1,3-propanediol, 1,3-butanediol, 1,4-butanediol, 1,5-pentanediol, 2-methylpropane-1,3-diol, neopentyl glycol, 1,6-hexanediol, diethylene glycol, dipropylene glycol, glycerol, trimethylolpropane, di- and trifunctional polyether polyols, where the polyether polyol has been formed from a di- or tri-H-functional starter substance and propylene oxide or a di- or tri-H-functional starter substance, propylene oxide and ethylene oxide. The polyether polyols preferably have a number-average molecular weight Mₙ in the range from 62 to 4500 g/mol and in particular a number-average molecular weight Mₙ in the range from 62 to 3000 g/mol, very particularly preferably a molecular weight of 62 to 1500 g/mol. The polyether polyols preferably have a functionality of ≥2 to ≤3.

In a preferred embodiment of the invention, the polyether carbonate polyol A is obtainable by the addition of carbon dioxide and alkylene oxides to H-functional starter substances using multimetal cyanide catalysts (DMC catalysts). The production of polyether carbonate polyols by the addition of alkylene oxides and CO₂ to H-functional starter substances using DMC catalysts is known, for example, from EP-A 0222453, WO-A2008/013731 and EP-A 2115032.

DMC catalysts are known in principle from the prior art for homopolymerisation of epoxides (see for example U.S. Pat. No. 3,404,109, U.S. Pat. No. 3,829,505, U.S. Pat. No. 3,941,849, and U.S. Pat. No. 5,158,922). DMC catalysts, which are described for example in U.S. Pat. No. 5,470,813, EP-A 700 949, EP-A 743 093, EP-A 761 708, WO-A97/40086, WO-A98/16310 and WO-A00/47649, have a very high activity in the homopolymerisation of epoxides and make it possible to produce polyether polyols and/or polyether carbonate polyols at very low catalyst concentrations (25 ppm or less). A typical example is provided by the high-activity DMC catalysts described in EP-A 700 949 which, as well as a double metal cyanide compound (e.g., zinc hexacyanocobaltate (III)) and an organic complex ligand (e.g., t-butanol), also contain a polyether having a number-average molecular weight Mₙ of greater than 500 g/mol.

The DMC catalyst is usually employed in an amount of ≤1% w/w, preferably in an amount of % w/w, particularly preferably in an amount of ≤500 ppm and in particular in an amount of ≤300 ppm based in each case on the weight of the polyether carbonate polyol.

In a preferred embodiment of the invention, the polyether carbonate polyol A1 has a content of carbonate groups (“units originating from carbon dioxide”), calculated as CO₂, of ≥2.0 and 30.0% w/w, preferably of and 28.0% w/w and particularly preferably of 10.0 and 25.0% w/w.

In a further embodiment of the process according to the invention, the polyether carbonate polyol(s) according to A1 has/have a hydroxyl number of 20 mg of KOH/g to ≤250 mg of KOH/g and is/are obtainable by copolymerisation of ≥2.0 wt % to 30.0 wt % of carbon dioxide and ≥70 wt % to ≤98 wt % of propylene oxide in the presence of a hydroxy-functional starter molecule, for example trimethylolpropane and/or glycerol and/or propylene glycol and/or sorbitol. The hydroxyl number may be determined according to DIN 53240.

A further embodiment uses a polyether carbonate polyol A1, containing blocks according to formula (IX) wherein the e/f ratio is from 2:1 to 1:20.

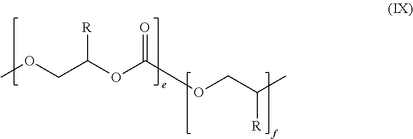

A further embodiment of the invention uses component A1 in an amount of 100 parts by wt.

### Component A2

Component A2 comprises polyether polyols having a hydroxyl number according to DIN 53240 of 20 mg of KOH/g to ≤250 mg of KOH/g, preferably of ≥20 to ≤112 mg of KOH/g and particularly preferably ≥20 mg of KOH/g to ≤80 mg of KOH/g and is free from carbonate units. The production of the compounds according to A2 may be effected by catalytic addition of one or more alkylene oxides to H-functional starter compounds. Alkylene oxides (epoxides) that may be used are alkylene oxides having 2 to 24 carbon atoms. The alkylene oxides having 2 to 24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidised fats as mono-, di- and triglycerides, epoxidised fatty acids, C₁-C₂₄ esters of epoxidised fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. Alkylene oxides employed are preferably ethylene oxide and/or propylene oxide and/or 1,2-butylene oxide. Particular preference is given to using an excess of propylene oxide and/or 1,2-butylene oxide. The alkylene oxides may be supplied to the reaction mixture individually, in admixture or successively. The copolymers may be random or block copolymers. When the alkylene oxides are metered in successively, the products (polyether polyols) produced comprise polyether chains having block structures.

The H-functional starter compounds have functionalities of ≥2 to ≤6 and are preferably hydroxy-functional (OH-functional). Examples of hydroxy-functional starter compounds are propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerol, trimethylolpropane, triethanolamine, pentaerythritol, sorbitol, sucrose, hydroquinone, catechol, resorcinol, bisphenol F, bisphenol A, 1,3,5-trihydroxybenzene, methylol-group-containing condensates of formaldehyde and phenol or melamine or urea. These can also be used as a mixture. The starter compound employed is preferably 1,2-propylene glycol and/or glycerol and/or trimethylolpropane and/or sorbitol.

The polyether polyols according to A2 have a content of ≥0 to ≤60% w/w, preferably of ≥0 to ≤40% w/w, especially preferably ≥0 to ≤25 w/w of ethylene oxide.

### Component A3

Component A3 comprises polyether polyols having a hydroxyl number according to DIN 53240≥20 mg of KOH/g to ≤250 mg of KOH/g, preferably of ≥20 mg of KOH/g to ≤112 mg of KOH/g and especially preferably ≥20 mg of KOH/g to ≤80 mg of KOH/g.

The production of component A3 is performed, in principle, analogously to component A2, wherein the content of ethylene oxide in the polyether polyol is adjusted to >60% w/w, preferably >65% w/w.

The same substances as were described for component A2 are worth considering as alkylene oxides and H-functional starter compounds.

However, those substances that are preferably worth considering as H-functional starter compounds are those with a functionality of ≥3 to ≤6, especially preferably of 3, so that polyethertriols are produced. Preferred starter compounds with a functionality of 3 are glycerol and/or trimethylolpropane, wherein glycerol is particularly preferred.

In a preferable embodiment, component A3 is a glycerol-started, trifunctional polyether with an ethylene oxide proportion of 68 to 73% w/w and a hydroxyl number of 35 to 40 mg of KOH/g.

### Component A4

Component A4 comprises polymer polyols, PHD polyols and PIPA polyols.
polymer polyols are polyols containing proportions of solid polymers produced by the radical polymerisation of suitable monomers, such as styrene or acrylonitrile in a basic polyol, such as a polyether polyol and/or polyether carbonate polyol.
PHD (Polyurea dispersion) polyols are produced, for example, by in situ polymerisation of an isocyanate or an isocyanate mixture with a diamine and/or hydrazine in a polyol, preferably a polyether polyol. Preferably, the PHD dispersion is produced by reacting an isocyanate mixture used from a mixture of 75 to 85% w/w of 2,4-tolylene diisocyanate (2,4-TDI) and 15 to 25% w/w of 2,6-tolylene diisocyanate (2,6-TDI) with a diamine and/or hydrazine in a polyether polyol, preferably a polyether polyol and/or polyether carbonate polyol, produced by alkoxylation of a trifunctional starter (for example, glycerol and/or trimethylolpropane), in the case of the polyether carbonate polyol in the presence of carbon dioxide. Methods for producing PHD dispersions are described, for example, in U.S. Pat. No. 4,089,835 and U.S. Pat. No. 4,260,530.
the PIPA polyols are polyether polyols and/or polyether carbonate polyols by polyisocyanate-polyaddition modified with alkanolamine or preferably triethanolamine, wherein the polyether(carbonate)polyol has a functionality of 2.5 to 4 and a hydroxyl number of ≥3 mg of KOH/g to ≤112 mg of KOH/g (molecular weight 500 to 18000). Preferably, the polyether polyol is “EO-capped”, i.e. the polyether polyol contains terminal ethylene oxide groups. PIPA polyols are described in detail in GB 2 072 204 A, DE 31 03 757 A1 and US 4 374 209 A.

### Component A5

All polyhydroxy compounds of which the expert is familiar and which do not fall under the definition of components A1 to A4, and which preferably have a mean OH functionality of ≥1.5, can be used as component A5.

These can be, for example, low molecular diols (e.g. 1,2-ethanediol, 1,3- or 1,2-propanediol, 1,4-butanediol), triols (e.g. glycerol, trimethylolpropane) and tetraols (e.g. pentaerythritol), polyester polyols, polythioether polyols or polyacrylate polyols, and polyether polyols or polycarbonate polyols not falling under the definition of components A1 to A4. Also, ethylene-diamine- and triethanolamine-started polyethers can be used, for example. These compounds do not belong to the compounds coming under the definition of component B2.

### Component B1

Component B1 comprises urea and derivatives of the urea. Derivatives of the urea that may be quoted, for example, are aminoalkyl ureas, such as (3-dimethylaminopropylamine)-urea and 1,3-bis[3-(dimethylamino)propyl]urea. Mixtures of urea and urea derivatives may also be used.

Preferably, only urea is used in component B1.

Component B1 is used in amounts of ≥0.05 to ≤1.5 parts by wt., preferably of ≥0.1 to ≤0.5 parts by wt., especially preferably of ≥0.25 to ≤0.35 parts by wt., relative to the sum of the parts by wt. of components A1 to A2.

### Component B2

Component B2 is used in amounts of ≥0.03 to ≤1.5 parts by wt., preferably ≥0.03 to ≤0.5 parts by wt., especially preferably of ≥0.1 to ≤0.3 parts by wt., quite especially preferably of ≥0.2 to ≤0.3 parts by wt., relative to the sum of the parts by wt. of components A1 to A2.

Preferably, the content of aminic catalysts in component B2 is no more than 50% w/w relative to component B1, especially preferably no more than 25% w/w relative to component B1. Particularly especially preferably, component B2 is free from aminic catalysts.

For example, tin(ii) salts of carboxylic acids can be used as catalysts of component B2, wherein preferably the underlying carboxylic acid has from 2 to 20 carbon atoms respectively. The tin(ii) salt of 2-ethylhexane acid (i.e. tin(ii)-(2-ethylhexanoate) or tin octoate), the tin(ii) salt of 2-butyloctanoic acid, the tin(ii) salt of 2-hexyldecanoic acid, the tin(ii) salt of neodecanoic acid, the tin(ii) salt of isononanoic acid, the tin(ii) salt of oleic acid, the tin(ii) salt of ricinoleic acid and tin(ii) laurate are especially preferred.

Aminic catalysts may be mentioned, where they may be possibly used in small amounts (see above): aliphatic tertiary amines (for example, trimethyl amine, tetramethyl butane diamine, 3-dimethylaminopropylamine, n,n-bis(3-dimethylaminopropyl)-n-isopropanolamine), cycloaliphatic tertiary amines (for example, 1,4-diazabicyclo (2,2,2) octane), aliphatic amino ethers (for example, bis dimethyl aminoethyl ether, 2-[2-(dimethyl amino)ethoxy]ethanol and n,n,n-trimethyl-n-hydroxyethyl-bis aminoethyl ether), cycloaliphatic amino ethers (for example, n-ethylmorpholine), aliphatic amidines and cycloaliphatic amidines.

### Component C

Di- and/or polyisocyanates which are suitable include aliphatic, cycloaliphatic, araliphatic, aromatic and heterocyclic polyisocyanates, as described, for example, by W. Siefken in Justus Liebigs Annalen der Chemie, 562, pp. 75 to 136, represented by formula (V)

Q(NCO)ₙ, (V)
in which
n=2-4, preferably 2-3,
and
Q stands for an aliphatic hydrocarbon residue with 2-18, preferably 6-10 C atoms, a cycloaliphatic hydrocarbon residue with 4-15, preferably 6-13 C atoms or an araliphatic hydrocarbon residue with 8-15, preferably 8-13 C atoms.

The polyisocyanates are for example those described in EP-A 0 007 502, pp. 7-8. Preference is generally given to the technically easily obtainable polyisocyanates, for example 2,4- and 2,6-tolylene diisocyanate and any desired mixtures of these isomers (“TDI”); polyphenylpolymethylene polyisocyanates as prepared by aniline-formaldehyde condensation and subsequent phosgenation (“crude MDI”), and polyisocyanates having carbodiimide groups, urethane groups, allophanate groups, isocyanurate groups, urea groups or biuret groups (“modified polyisocyanates”), especially those modified polyisocyanates which derive from tolylene 2,4- and/or 2,6-diisocyanate or from 4,4′- and/or 2,4′-diphenylmethane diisocyanate. The polyisocyanate is employed preferably a compound selected from the group consisting of 2,4- and 2,6-tolylene diisocyanate, 4,4′- and 2,4′- and 2,2′-diphenylmethane diisocyanate and polyphenyl polymethylene polyisocyanate (“polycyclic MDI”). For preference, 2,4- and/or 2,6-tolylene diisocyanate is/are used.

In a further embodiment of the process according to the invention the isocyanate component B comprises a tolylene diisocyanate isomer mixture composed of 55 to 90 wt % of 2,4-TDI and 10 to 45 wt % of 2,6-TDI.

In a further embodiment of the inventive method, the isocyanate component B comprises 100% of 2,4-tolylene diisocyanate.

In one embodiment of the inventive method, the index is ≥90 to ≤120. Preferably, the index falls in the range from ≥100 to ≤115, particularly preferably ≥102 to ≤110. The index indicates the percentage ratio of the amount of isocyanate actually used to the stoichiometric amount, i.e. calculated for the reaction of the OH equivalent calculated amount of isocyanate groups (NCO).

Index=[isocyanate amount used):(isocyanate amount calculated)·100 (VI)

### Component D

Water and/or physical propellants are used as component D. Physical propellants used include, for example, carbon dioxide and/or volatile organic substances. Water is used as component D for preference.

### Component E

Excipients and additives are used as component E, such as
a) surfactant additives, such as emulsifiers and foam stabilisers, in particular those with low emissions, for example, products in the Tegostab® BF range,
b) Additives such reaction retardants (e.g. acidic reacting substances such as hydrochloric acid or organic acid halides), cell regulators (for example, paraffins or fatty alcohols or dimethylpolysiloxanes), pigments, dyes, flame retardants, (for example, tricresyl phosphate or ammonium polyphosphate), further stabilisers against aging and weathering effects, antioxidants, plasticisers, fungistatic and bacteriostatic substances, fillers (for example, barium sulfate, kieselgur, carbon black or whiting) and release agents.

These excipients and additives that may possibly be used are described, for example, in EP-A 0 000 389, pp. 18-21. Further examples of excipients and additives that may be added according to the invention as well as details about the method of use and effects of these excipients and additives are described in the Kunststoff-Handbuch, Volume VII, published by G. Oertel, Carl-Hanser-Verlag, Munich, 3rd Edition, 1993, for example on pp. 104-127.

To produce the polyurethane foams, the reactions components are reacted according to the well-known grading process which is often performed by machine, e.g. as described in EP-A 355 000. Details of processing apparatus, also worth considering according to the invention, are described in the Kunststoff-Handbuch, Volume VII, published by Vieweg and Höchtlen, Carl-Hanser-Verlag, Munich 1993, e.g. on pp. 139 to 265.

The polyurethane foams appear preferably as flexible polyurethane foams and can be produced as shaped or also as blocks of foam, preferably as blocks of foam. Thus, the subject matters of the invention include a method for producing the polyurethane foams, the polyurethane foams produced by this method, the flexible polyurethane foam blocks or polyurethane foam shapes produced by this method, the use of the flexible polyurethane foams for producing shaped parts as well as the shaped parts themselves.

The polyurethane foams, preferably flexible polyurethane foams, obtainable according to the invention can be used, for example, in: furniture cushioning, textile inserts, mattresses, automotive seats, head rests, arm rests, sponges, foam sheeting for use in automobile parts, such as, for example, roof liners, door trim panels, seat coverings and structural elements.

The soft foams according to the invention have a bulk density, according to DIN EN ISO 845, in the range from ≥16 to ≤60 kg/m³, preferably ≥20 to ≤50 kg/m³, wherein the low bulk densities are obtained by liquid CO₂.

### EXAMPLES

The present invention is explained with the aid of the following examples without being limited, however, by them. Namely:

A1: propylene oxide-based polyether carbonate polyol, hydroxyl number 56 mg of KOH/g, content of carbon dioxide 20% w/w

A2: trifunctional polyether polyol based on glycerol with a hydroxyl number 48 mg of KOH/g, obtained by copolymerisation of 12% w/w of ethylene oxide with 88% w/w of propylene oxide

A1/A2: mixture of A1 and A2 in a ratio according to the invention

A3: trifunctional polyether polyol based on glycerol with a hydroxyl number 37 mg of KOH/g, content of ethylene oxide >60 to <80% w/w

B1-1: Urea, a commercial product from Borealis AG, Vienna

B1-2: DABCO NE500, a commercial product from Versum Materials, Norderstedt, catalyst 3-dimethylaminopropyl urea-based

B2-1: Niax Catalyst A-1: a commercial product from Momentive Performance Materials, bis[2-(n,n-dimethylamino)ethyl]ether-based

B2-2: DABCO T-9, a commercial product from Versum Materials, Norderstedt, tin-(ii)-ethylhexanoate

E: Tegostab BF 2370, a commercial product from Evonik Nutrition & Care, Essen

C-1: Desmodur T 80, a commercial product from Covestro AG

C-2: Desmodur TB 1, a commercial product from Covestro AG

Emission determination: cyclic propylene carbonate and ancillary components:
Headspace-GC and -GC/MS for cyclic propylene carbonate in flexible foam samples:
A flexible foam sample weighing approx. 100 mg within approx. ±0.3 mg was placed in a 22 ml headspace glass vial, closed carefully with a silicone septum, and tempered in the preheated oven of the headspace autosampler (PerkinElmer Turbomatrix, serial number. M41L0505273) for 15 min at 140° C. Next, the vapour space was injected at a pressure of 2.35 bar in the helium flow into the injector block of the gas chromatograph (Thermo Scientific, Trace-GC-Ultra, serial number 6201252621). The injection volume was divided into two equal, non-polar Rxi-5Sil MS-type columns (Restek, 20 m length, 0.15 mm internal diameter, 2.0 μm thick). The oven temperature remained at 45° C. for 2 min and was raised to 150° C. at 12° C./min and 310° C. at 45° C./min. One of the columns lead to the flame ionisation detector (FID). The other terminated in a directly coupled quadrupole mass spectrometer with 70 eV electron impact ionisation (Thermo Scientific, ISQ-MS, serial number ISQ121046). The cyclic propylene carbonate (CAS-Nr. 108-32-7) was recorded quantitatively by FID response and its identity confirmed by GC/MS.

The educts listed in Table 1 were reacted in the stated amounts according to the so-called classification process and heated up in the heating cabinet at temperatures of about 110° C. for 10 min. The emissions of cyclic propylene carbonate and ancillary components were determined by headspace-GC and -GC/MS methods. It was shown that, when using urea or urea derivatives (tests 3 and 4), the emission was significantly less than was the case of comparison tests 1 and 2, in which no urea and no urea derivatives were used.

TABLE 1

| | | Test no. | Test no. | Test no. | Test no. |
|---|---|---|---|---|---|
| COMPONENTS | | 1 | 2 | 3 | 4 |
| A1/A2 | [pts by wt.] | 94.34 | 94.34 | 94.22 | 93.79 |
| D | [pts by wt.] | 4.25 | 4.25 | 4.24 | 4.22 |
| E | [pts by wt.] | 1.13 | 1.13 | 1.13 | 1.41 |
| B2-1 | [pts by wt.] | 0.11 | 0.11 | 0 | 0 |
| B1-1 | [pts by wt.] | 0 | 0 | 0.24 | 0 |
| B1-2 | [pts by wt.] | 0 | 0 | 0 | 0.28 |
| B2-2 | [pts by wt.] | 0.17 | 0.17 | 0.17 | 0.30 |
| C-1 | [pts by wt.] | 52.8 | 26.4 | 52.8 | 52.5 |
| C-2 | [pts by wt.] | 0 | 26.4 | 0 | 0 |
| Water total | [pts by wt.] | 4.25 | 4.25 | 4.24 | 4.22 |
| Index | [—] | 108 | 108 | 108 | 108 |

| | | | | |
|---|---|---|---|---|
| Cycl. propylene carbonate | 42 mg/kg | 22 mg/kg | 13 mg/kg | 16 mg/kg |
| NIAX A-1/2-ethylhexane acid | 129 mg/kg | 34 mg/kg | 77 mg/kg | 66 mg/kg |
| Σ ancillary components | 25 mg/kg | 25 mg/kg | 15 mg/kg | 20 mg/kg |

1. A method for producing polyurethane foams comprising reacting:
A an isocyanate-reactive component comprising:
A1 ≥40 to ≤100 parts by wt. of one or more polyether carbonate polyols having a hydroxyl number according to DIN 53240 of ≥20 mg of KOH/g to ≤120 mg of KOH/g,
A2 ≤60 to ≥0 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein said polyether polyols A2 are free from carbonate units,
A3 ≤20 to ≥0 parts by wt., relative to the sum of the parts by wt. of components A1 and A2, of one or more polyether polyols having a hydroxyl number according to DIN 53240≥20 mg of KOH/g to ≤250 mg of KOH/g, and a content of ethylene oxide of >60% w/w, wherein said polyether polyols A3 are free from carbonate units,
A4 ≤40 to ≥0 parts by wt., relative to the sum of the parts by wt. of components A1 and A2, of one or more polymer polyols, PHD polyols and/or PIPA polyols,
and
A5 ≤40 to ≥0 parts by wt., relative to the sum of the parts by wt. of components A1 and A2, of polyols, which do not fall under the definition of components A1 to A4;
B a catalyst component comprising:
B1 ≥0.05 to ≤1.5 parts by wt., relative to the sum of the parts by wt. of components A1 and A2, of urea and/or derivatives of the urea,
and
B2 ≥0.03 to ≤1.5 parts by wt., relative to the sum of the parts by wt. of components A1 and A2, of catalysts other than those of component B1, wherein the content of aminic catalysts in component B2 may be no greater than 50% w/w relative to component B1,
with
C di and/or polyisocyanates,
D water and/or physical propellants,
E excipients and additives as required,
wherein said reaction takes place at an isocyanate index of ≥90 to ≤120,
wherein all stated parts by weight of components A1, A2, A3, A4, A5, B1 and B2 are normalised such that the sum of the parts by weight A1+A2 totals 100 in the composition, and
wherein neither urea nor its derivatives belong to the “aminic catalysts” mentioned in B2.

2. The method according to claim 1, wherein component A is free from components A3 and/or A4.

3. The method according to claim 1, wherein component A comprises:
A1 ≥65 to ≤75 parts by wt. of one or more polyether carbonate polyols having a hydroxyl number according to DIN 53240 of ≥20 mg of KOH/g to ≤120 mg of KOH/g,
and
A2 ≤35 to ≥25 parts by wt. of one or more polyether polyols having a hydroxyl number according to DIN 53240 of ≥20 mg of KOH/g to ≥250 mg of KOH/g and a content of ethylene oxide of ≥0 to ≥60% w/w, wherein the polyether polyols A2 are free from carbonate units.

4. The method according to claim 1, wherein component A1 comprises a polyether carbonate polyol, obtainable by copolymerisation of carbon dioxide, one or more alkylene oxides, in the presence of one or more H-functional starter molecules, wherein the resultant polyether carbonate polyol has a CO₂ content of 15 to 25% w/w.

5. The method according to claim 1, wherein component A comprises:
A1 ≥65 to ≤75 parts by wt. of one or more polyether carbonate polyols having a hydroxyl number according to DIN 53240 of ≥20 mg of KOH/g to ≤120 mg of KOH/g, and
A2 ≤35 to ≥25 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,
and
A3 ≤20 to ≥2 parts by wt., relative to the sum of the parts by wt. of components A1 and A2, of one or more polyether polyols having a hydroxyl number according to DIN 53240≥20 mg of KOH/g to ≤250 mg of KOH/g, and a content of ethylene oxide of >60% w/w, wherein the polyether polyols A3 are free from carbonate units.

6. The method according to claim 1, wherein component A comprises:
A1 ≥65 to ≤75 parts by wt. of one or more polyether carbonate polyols having a hydroxyl number according to DIN 53240 of ≥20 mg of KOH/g to ≤120 mg of KOH/g,
A2 ≤35 to ≥25 parts by wt. of one or more polyether polyols having a hydroxyl number according to DIN 53240 of ≥20 mg of KOH/g to ≤250 mg of KOH/g and a content of ethylene oxide of ≥0 to ≤60% w/w, wherein the polyether polyols A2 are free from carbonate units,
and
A4 ≤20 to ≥2 parts by wt., relative to the sum of the parts by wt. of components A1 and A2, of one or more polymer polyols, PHD polyols and/or PIPA polyols.

7. The method according to claim 1, wherein component B1 is present in an amount of ≥0.1 to ≤0.5 parts by wt., relative to the sum of the parts by wt. of components A1 to A2.

8. The method according to claim 1, wherein B1 comprises urea.

9. The method according to claim 1, component C) comprises 2,4-TDI and/or 2,6-TDI.

10. A polyurethane foam, obtainable by a method according to claim 1.

11. The polyurethane foam according to claim 10, wherein said foam is a flexible polyurethane foam.

12. An article comprising the polyurethane foam according to claim 10 in furniture, textile inserts, bedding, automotive and/or construction industries.

13. The method according to claim 1, wherein component B1 is present in an amount of ≥0.25 to ≤0.35 parts by wt., relative to the sum of the parts by wt. of components A1 to A2.
